(19) United States
(12) Patent Application Publication
(10) Pub. No.: US 2019/0119959 A1
(43) Pub. Date: Apr. 25, 2019

(54) LATCH WITH ADJUSTABLE PRIMARY/FINAL POSITION

(71) Applicant: NIO USA, Inc., San Jose, CA (US)

(72) Inventor: Padmanabhan Kumar, Fremont, CA (US)

(21) Appl. No.: 15/793,037

(22) Filed: Oct. 25, 2017

(51) Int. Cl. E05B 83/24; E05C 3/04; E05B 17/00; E05B 81/42

(52) U.S. Cl. CPC E05B 83/243; E05C 3/042; E05B 2015/0431; E05B 81/42; E05B 17/0037

(57) ABSTRACT

A latch having an adjustable primary/final position includes mounting plate with a plurality of mounting holes or mounting locations to which a primary pawl can be selectively attached. The latch also includes a latch cam that is rotatable between an open position and a primary, fully engaged position. When in the primary, fully engaged position, the latch cam secures a striker within a receiving slot of the mounting plate. The position of the striker within the receiving slot when the latch cam is in the fully engaged position can be adjusted by selectively attaching the primary pawl to a different one of the plurality of mounting holes or mounting locations.

### FIELD

The present disclosure is generally directed to vehicle latches, and more particularly to adjustable vehicle latches.

### BACKGROUND

Latches have long been used to secure vehicle doors in the closed position. Most such latches have two positions: a primary position and a secondary position. The secondary position is a partially latched position in which the vehicle door is not fully closed and, typically, does not lie flush with the body of the vehicle. The primary position is the fully latched position, in which the vehicle door is fully closed and, typically, lies flush with the body of the vehicle. Known latches must be physically moved and/or adjusted in an iterative process during installation in a vehicle, until the latch is positioned so that the primary position of the latch corresponds to the vehicle door being fully closed and lying flush with the surrounding vehicle surfaces.

U.S. Pat. No. 6,014,876, entitled “Adjustable Locking for Hood Latch” and filed on Jan. 4, 1999, describes a tamper-proof locking system for special vehicle compartments (e.g., the engine compartment) that uses a coded key to release the latch. U.S. Pat. No. 6,422,616, entitled “Adjustable Hood Latch Assembly” and filed on Mar. 1, 2000, describes a latching mechanism for retaining a closure of a motor vehicle compartment in a closed or latched position, in which the force applied to a striker spring may be adjusted to allow use of the latching mechanism with hoods of varying size and/or weight. Applicant incorporates the entirety of these references herein by reference.

### BRIEF DESCRIPTION OF THE DRAWINGS

FIG. 1 shows a vehicle according to embodiments of the present disclosure;

FIG. 2A shows a latch according to one embodiment of the present disclosure in a first position;

FIG. 2B shows a latch according to the embodiment of FIG. 2A in a second position;

FIG. 2C shows a latch according to the embodiment of FIG. 2A in a third position;

FIG. 2D shows a latch according to the embodiment of FIG. 2A in a fourth position;

FIG. 2E shows a latch according to the embodiment of FIG. 2A in a fifth position;

FIG. 3A shows a latch according to another embodiment of the present disclosure in a first position;

FIG. 3B shows a latch according to the embodiment of FIG. 3A in a second position;

FIG. 4A shows a latch according to yet another embodiment of the present disclosure in a first position; and

FIG. 4B shows a latch according to the embodiment of FIG. 4A in a second position.

### DETAILED DESCRIPTION

Embodiments of the present disclosure will be described in connection with a vehicle, and more particularly with respect to an automobile. However, for the avoidance of doubt, the present disclosure encompasses the use of the aspects described herein in vehicles other than automobiles.

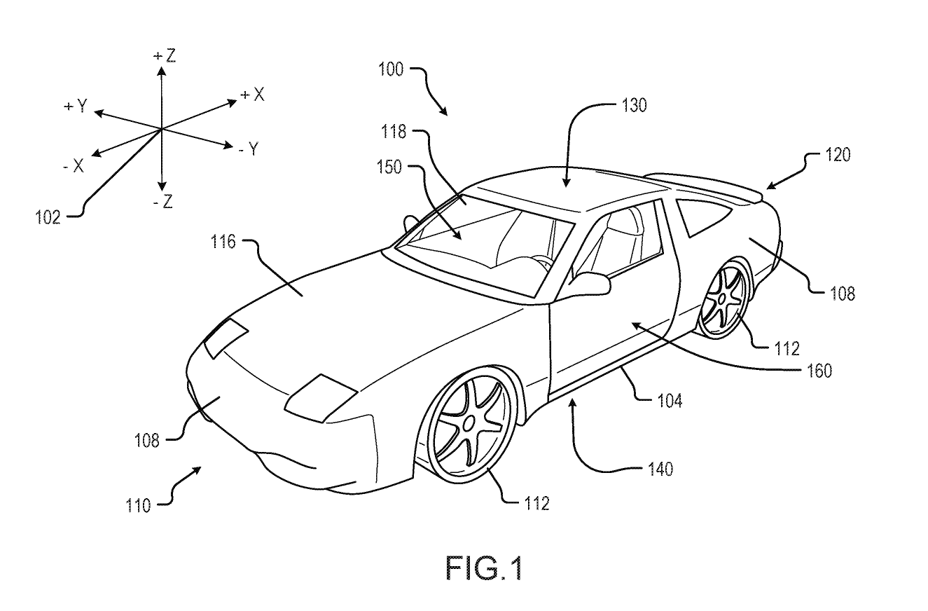

FIG. 1 shows a perspective view of a vehicle 100 in accordance with embodiments of the present disclosure. The vehicle 100 comprises a vehicle front 110, vehicle aft 120, vehicle roof 130, at least one vehicle door 160, a vehicle undercarriage 140, and a vehicle interior 150. The vehicle 100 may include a frame 104, one or more body panels 108 mounted or affixed thereto, and a windshield 118. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components, etc.

Coordinate system 102 is provided for added clarity in referencing relative locations in the vehicle 100. In this detailed description, an object is forward of another object or component if the object is located in the −X direction relative to the other object or component. Conversely, an object is rearward of another object or component if the object is located in the +X direction relative to the other object or component. Similarly, forward movement refers to movement in the −X direction, and backward movement refers to movement in the −X direction. The axes of the coordinate system 102 are referenced throughout this description.

The vehicle 100 may be, by way of example only, an electric vehicle or a gas-powered vehicle. Where the vehicle 100 is an electric vehicle, the vehicle 100 may comprise one or more electric motors powered by electricity from an on-board battery pack. The electric motors may, for example, be mounted near or adjacent an axis or axle of each wheel 112 of the vehicle, and the battery pack may be mounted on the vehicle undercarriage 140. In such embodiments, the front compartment of the vehicle, referring to the space located under the vehicle hood 116, may be a storage or trunk space. Where the vehicle 100 is a gas-powered vehicle, the vehicle 100 may comprise a gas-powered engine and associated components in the front compartment (under the vehicle hood 116), which engine may be configured to drive either or both of the front wheels 112 and the rear wheels 112. In some embodiments where the vehicle 100 is gas-powered, the gas-powered engine and associated components may be located in a rear compartment of the vehicle 100, leaving the front compartment available for storage or trunk space or for other uses. In some embodiments, the vehicle 100 may be, in addition to a battery-powered electric vehicle and a gas-powered vehicle, a hybrid electric vehicle, a diesel-powered vehicle, or a fuel cell vehicle.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, buses, automobiles, trains, railed conveyances, boats, ships, marine conveyances, submarine conveyances, airplanes, space craft, flying machines, human-powered conveyances, and the like.

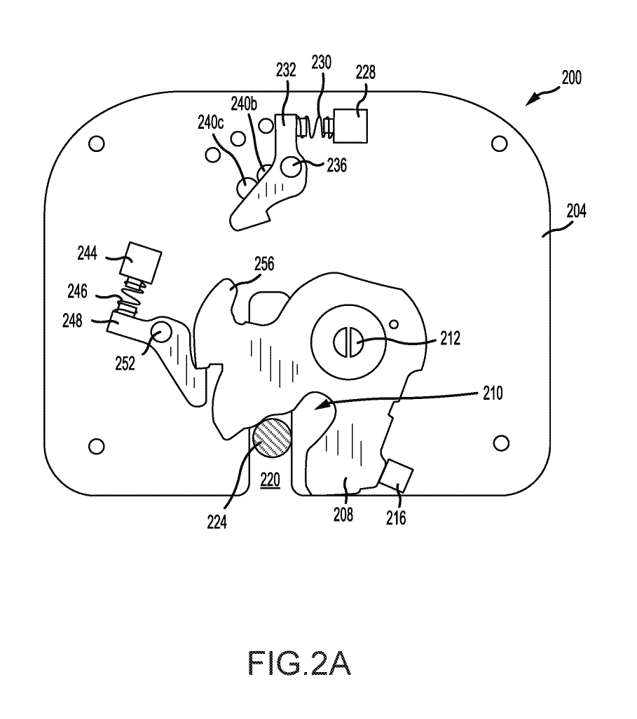

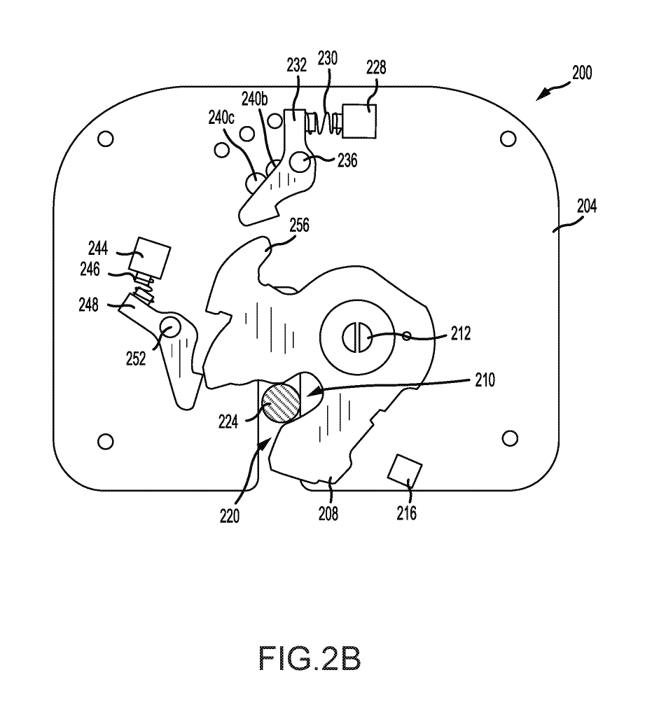

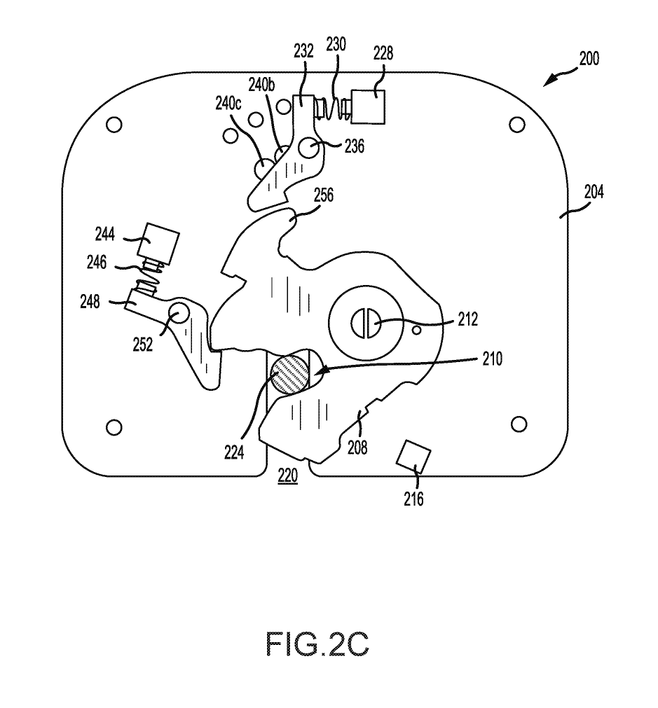

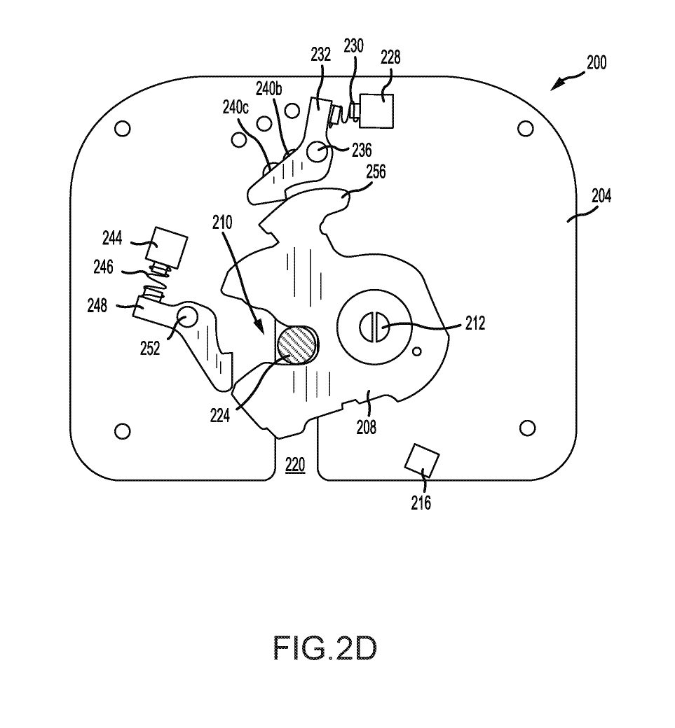

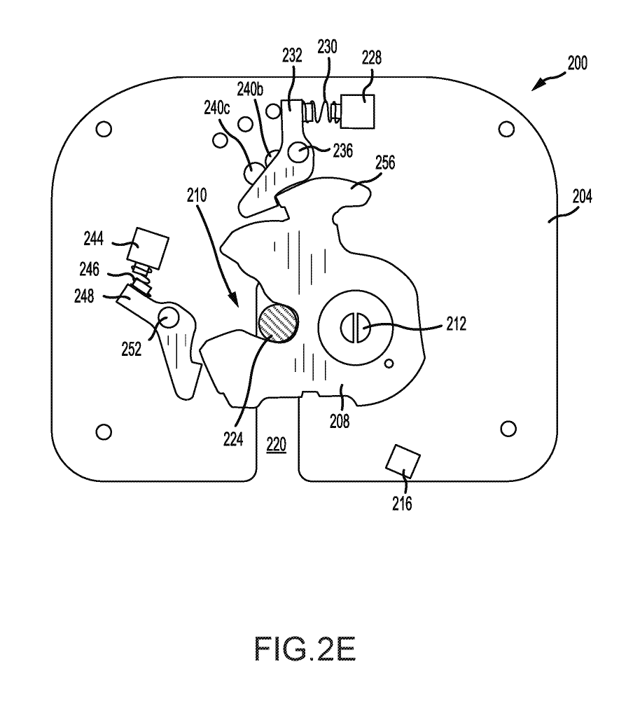

Referring now to FIGS. 2A-2E, a latch 200 may be used in connection with a vehicle door 160, a vehicle hood 116, a vehicle trunk or liftgate, or any other vehicle component that requires latching. The latch 200 comprises a mounting plate 204, to which a latch cam 208 is rotatably secured at a pivot 212. The mounting plate 204, the latch cam 208, and the pivot 212 may be manufactured, for example, from a metal such as steel. The pivot 212 and latch cam 208 are positioned so that a latch cam slot 210 overlaps, through varying degrees of rotation, a receiving slot 220 in the mounting plate 204. A stop 216 prevents the latch cam from over-rotating in the counterclockwise direction. (Latches according to other embodiments of the present disclosure may be configured as a mirror-image of the latch 200, with the latch cam rotatably secured to a pivot positioned on the opposite side of the receiving slot as in the latch 200. In such embodiments, a stop such as the stop 216 may be provided to prevent the latch cam from over-rotating in the clockwise direction.)

The latch 200 further comprises a primary pawl 232 and a secondary pawl 248. The primary pawl 232 is rotatably and removably secured to the mounting plate 204 with a pivot 236. In some embodiments, the primary pawl 232 and the pivot 236 are integral (e.g., manufactured as a single component), while in other embodiments the primary pawl 232 is secured to the pivot 236, and the pivot 236 is removably attached to the mounting plate 204. Also in some embodiments, the primary pawl 232 rotates around the pivot 236, while in other embodiments the primary pawl 232 and the pivot 236 rotate relative to the mounting plate 204.

A first end of the primary pawl 232 is shaped to facilitate rotatable displacement of the primary pawl 232 when the latch cam 208 rotates clockwise, but to engage with the latch cam 208 to prevent counterclockwise rotation of the latch cam 208 once the latch cam 208 has been sufficiently rotated in the clockwise direction. A second end of the primary pawl 232 is adapted to engage a spring 230 or other biasing member that biases the second end of the primary pawl 232 away from the spring holder 228 (and thus biases the first end of the primary pawl 232 toward the latch cam 208). The primary pawl 232 may be operably connected to a handle, lever, or other device that may be used to displace the primary pawl 232 towards the spring holder 228 (and thus against the biasing force of the spring 230) to selectively disengage the primary pawl 232 from the latch cam 208 and allow the latch cam 208 to return to an open position (or at least to allow the latch cam 208 to return to the secondary, partially engaged position).

The secondary pawl 248 is rotatably secured to the mounting plate 204 with a pivot 252. A first end of the secondary pawl 248 is shaped to facilitate rotatable displacement of the secondary pawl 248 when the latch cam 208 rotates clockwise, but to engage with the latch cam 208 to prevent counterclockwise rotation of the latch cam 208 once the latch cam 208 has been sufficiently rotated in the clockwise direction. A second end of the secondary pawl 248 is adapted to engage a spring 246 or other biasing member that biases the second end of the secondary pawl 248 away from the spring holder 244 (and thus biases the first end of the secondary pawl 248 toward the latch cam 208). Like the primary pawl 232, the secondary pawl 248 may be operably connected to a handle, lever, or other device that may be used to displace the secondary pawl 248 towards the spring holder 244 (and thus against the biasing force of the spring 246) to selectively disengage the secondary pawl 248 from the latch cam 208 and allow the latch cam 208 to return to an open position.

Although the latch 200 is shown as utilizing compression springs 230 and 246 in FIGS. 2A-2E, other types of springs may also be used to bias the primary pawl 232 and the secondary pawl 248 away from the spring holders 228 and 244, respectively, and toward the latch cam 208. For example, in some embodiments, a spring holder may be positioned on the opposite side of the primary and secondary pawls 232 and 248 as the spring holders 228 and 244, and extension springs may be used to bias the primary pawl 232 and the secondary pawl 248 toward the respective spring holders. In other embodiments, torsion springs may be operably connected to the pivots 236 and 252 as well as to the primary pawl 232 and the secondary pawl 248, respectively, for biasing the primary and secondary pawls 232 and 248 toward the latch cam 208. When torsion springs are used, spring holders 228 and 244 may be omitted from the latch 200.

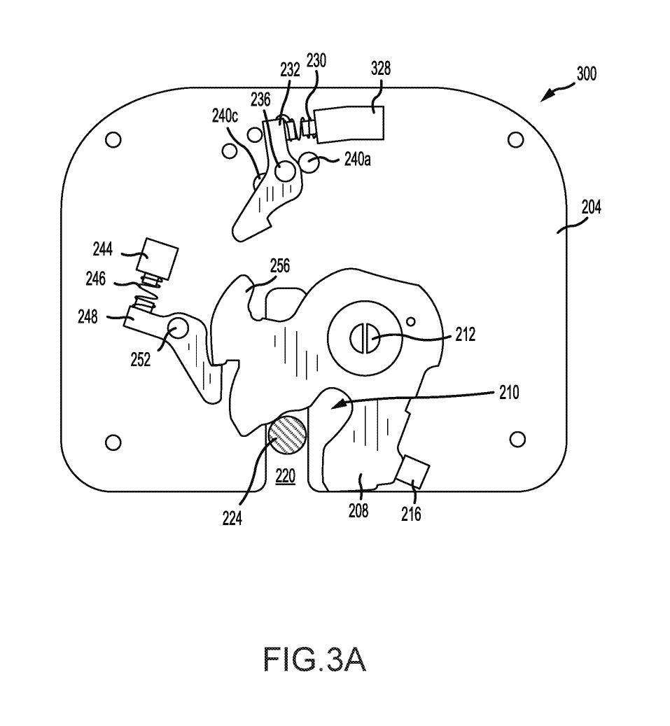

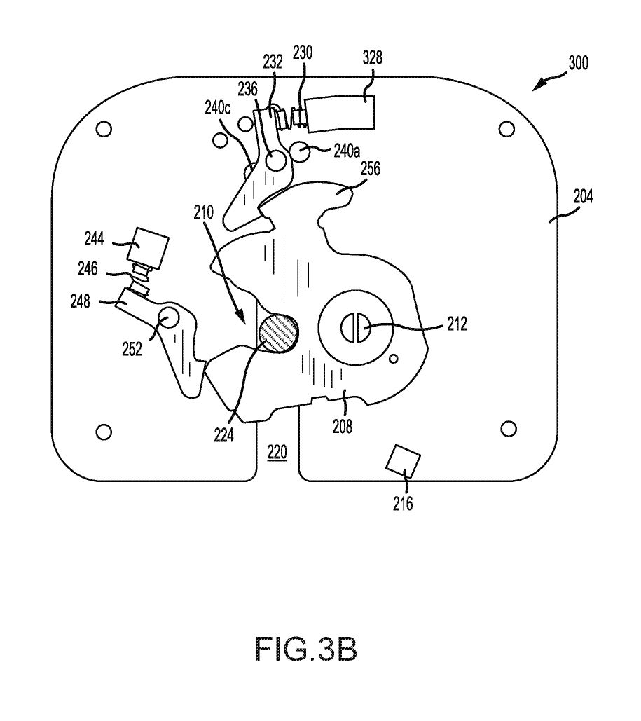

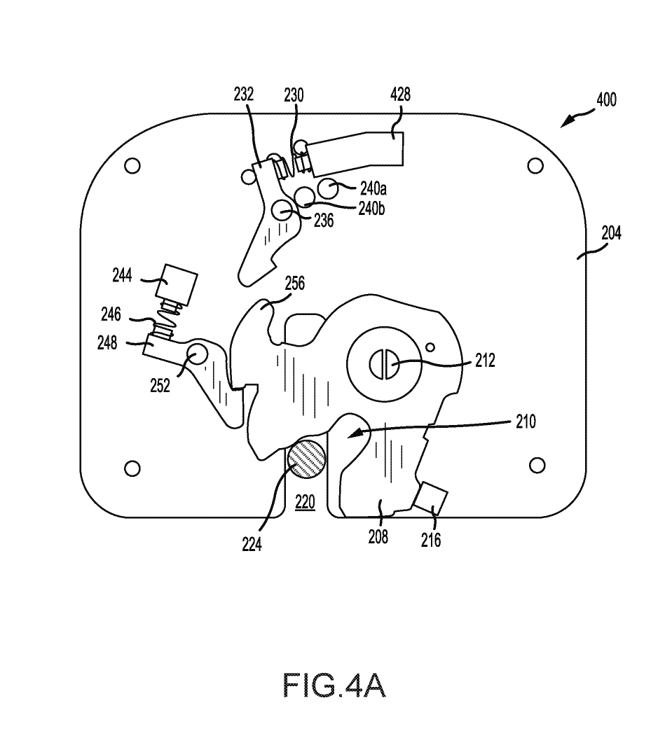

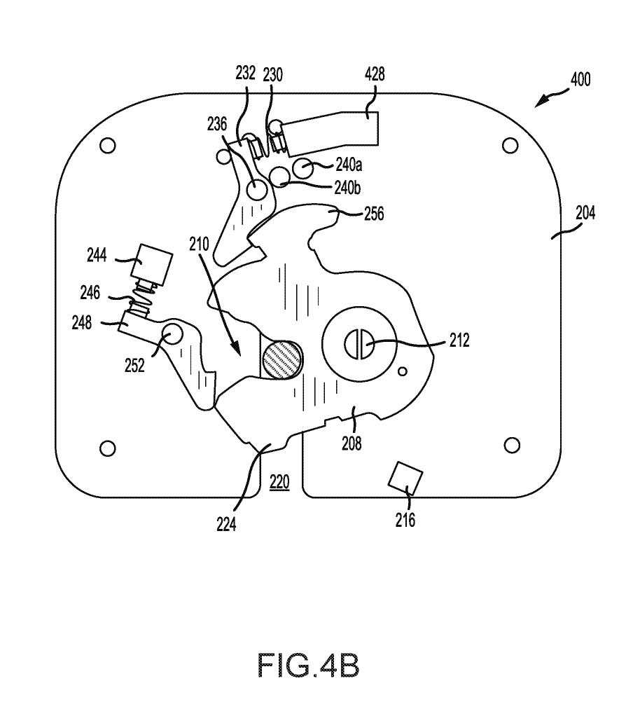

The mounting plate 204 further comprises three holes 240a (not visible in FIGS. 2A-2E, but shown in FIGS. 3A-4B) to which the pivot 236 of the primary pawl 232 may be removably attached. In FIGS. 2A-2E, the pivot 236 is removably attached to the hole 240a. The pivot 236 may be configured to snap in and out of the mounting holes 240, or the pivot 236 may comprise threads for engaging a nut that secures the pivot 236 in a given mounting hole 240. Alternatively, the mounting hole 240 may comprise internal threads, and the pivot 236 may be configured to thread into the mounting hole 240. In another embodiment, the pivot 236 may be secured in a given mounting hole 240 using a cotter pin. Although the mounting plate 204 is shown as comprising three mounting holes 240, in some embodiments the mounting plate 204 may have only two mounting holes 240, and in still other embodiments the mounting plate 204 may have more than three mounting holes 240. Additionally, while mounting holes 240 are shown in the drawings of the present disclosure, in other embodiments the mounting holes 240 may be replaced by mounting locations that may or may not comprise one or more actual holes.

The mounting plate 204 of the latch 200 may be mounted, in some embodiments, to the frame 104 of a vehicle such as the vehicle 100. The latch 200 may be mounted to the frame 104 using screws, bolts, rivets, or any other suitable fasteners. In some embodiments, the latch 200 may be welded to the frame 104. Regardless of how the latch 200 is secured to the frame 104, the hood, door, or other latching vehicle component is provided with a striker 224 that engages the latch 200 when the hood, door, or other latching vehicle component is closed. In other embodiments, the mounting plate 204 of the latch 200 may be mounted to the hood, door, or other latching vehicle component that will be latched to the vehicle frame (e.g., using any suitable fastener, or by welding), and a striker 224 may be installed on or otherwise affixed to the vehicle frame 104, such that the striker 224 engages the latch 200 when the hood, door, or other latching vehicle component is closed. The operation of the latch 200 is the same whether the latch 200 is mounted to the vehicle frame 104 or to the hood, door, or other latching vehicle component.

FIGS. 2A-2E show the changes in the position of the latch cam 208, the primary pawl 232, and the secondary pawl 248 as a striker 224 moves up the receiving slot 220 toward the center of the mounting plate 204 (which movement corresponds, for example, to the closing of a hood 116, a door 160, or another latching vehicle component to be latched shut). In FIG. 2A specifically, the position of the striker 224 and of the components of the latch 200 as shown in FIG. 2A correspond to the moment just before a hood, door, or other latching vehicle component is moved into the latched position, before the striker 224 contacts the latch cam 208 but after the striker 224 has already entered the receiving slot 220 of the mounting plate 204. At the moment depicted in FIG. 2A, the latch cam 208 rests against the stopper 216 and is engaged with the secondary pawl 248. The primary pawl 232 is not engaged with the latch cam 208, and the striker 224 is free to move out of the receiving slot 220 (which would occur, e.g., if a user of the vehicle 100 chose to re-open the door, hood, or other latching vehicle component).

FIG. 2B shows the latch 200 shortly after the striker 224 has contacted the latch cam 208. The striker 224 pushes against an inner surface of the latch cam slot 210, which causes the latch cam 208 to rotate around the pivot 212 in a clockwise direction. The rotation of the latch cam 208 displaces the secondary pawl 248, thus compressing the spring 246. In this position as well, the striker 224 is free to move out of the receiving slot 220.

In FIG. 2C, further movement of the striker 224 toward the center of the mounting plate 204 has resulted in further rotation of the latch cam 208 around the pivot 212. Here, the latch cam 208 has rotated sufficiently to allow the secondary pawl 248 to engage with an edge of the receiving slot 210 of the latch cam 208. Thus, the spring 246 has biased the secondary pawl 248 back toward the latched position, such that the secondary pawl 248 is positioned to prevent counterclockwise rotation of the latch cam 208. With the latch cam 208 and the secondary pawl 248 so positioned, the striker 224 is no longer free to move out of the receiving slot 220. The latch 200 is therefore in a secondary, partially latched position. The striker 224 is, however, free to continue moving up the receiving slot 220, toward the center of the mounting plate 204.

In FIG. 2D, continued movement of the striker 224 up the receiving slot 220 has caused further rotation of the latch cam 208, which has displaced the primary pawl 232 against the biasing force of the spring 230. If the rotation of the latch cam 208 were reversed (which would occur, e.g., if a user applied an opening force to a hood, door, or other latching vehicle component to which one of the latch 200 and the striker 224 is secured, thus causing the striker 224 to move towards the open end of the receiving slot 220), the latch cam 208 would rotate counterclockwise through a relatively small angular distance before engaging the secondary pawl 248. Once the latch cam 208 engages the secondary pawl 248, the latch cam 208 would prevent the striker 224 from moving further toward the open end of the receiving slot 220.

FIG. 2E shows the latch cam 208 fully rotated, such that the striker 224 is prevented from further movement within the receiving slot 220 (whether towards the center of the mounting plate 204 or towards the open end of the receiving slot 220) by the latch cam 208. Additionally, the latch cam 208 has been rotated sufficiently to allow the primary pawl 232 to be biased by the spring 230 back into a latched position in which the primary pawl 232 engages a protrusion 256 of the latch cam 208, such that the primary pawl 232 prevents counterclockwise rotation of the latch cam 208. The latch 200 is therefore in a primary, fully latched position. Only by displacing the primary pawl 232 and the secondary pawl 248 can the latch cam 208 be released to rotate counterclockwise sufficiently to free the striker 224 from the receiving slot 220 (and thus allow the hood, door, or other latching vehicle component to which the striker 224 or the latch 200 is affixed to open). Such displacement may be caused, for example, using a door handle or other device operably connected to the primary pawl 232 and the secondary pawl 248, and configured to rotate the primary pawl 232 and the secondary pawl 248 away from the latch cam 208.

Problematically, when a typical latch is first installed in a vehicle (whether affixed to the frame of the vehicle or installed on or in a door, hood, or other latching vehicle component), the relative position of the striker and the latch when the latch is in the primary, fully engaged or locked position may not correspond to a desirable position of the door, hood, or other latching vehicle component to which the latch or the striker is secured. In other words, if the latch is installed, for example, in a vehicle door and the striker is installed on a vehicle frame, the striker may move the latch cam to a locked position before the outside surface of the door is flush with the body panels surrounding the door. Alternatively, the striker may move the latch cam to a locked position only after the outside surface of the door has passed the point at which the outside surface of the door is flush with the body panels surrounding the door.

Consequently, the installation of the latch may need to be adjusted (e.g., by repositioning the latch on the frame or on or in the door, hood, or other latching vehicle component to which the latch is secured) until the striker moves the latch cam to a fully locked position precisely when the outside surface of the door is flush with the body panels surrounding the door. Often, such adjustments require an iterative process of repositioning the latch, testing whether the repositioned latch reaches the primary, fully latched position when the outside surface of the door is aligned with the body panels surrounding the door, again repositioning the latch based on the most recent test, repeating the testing, and so forth until the latch is in the proper position. In light of this problem, conventional latches are installed on slots or tracks, which facilitate the repositioning of the latch. However, as may be appreciated, this process wastes time (and therefore money).

To reduce the amount of guesswork and testing needed when installing a latch in a vehicle, the latch 200 comprises a movable primary pawl 232 that can be secured to any one of the mounting holes 240a, 240b, and 240c with the pivot 236. Instead of having to repeatedly reposition the latch 200 after initially installing the latch 200 in a vehicle (which repositioning may require the loosening and then tightening of a plurality of fasteners), the primary pawl 232 can simply be moved from one mounting hole 240 to another mounting hole 240 (which requires only the disengagement and re-engagement of the pivot 236). Moreover, the position of the mounting holes 240 may be selected to correspond to specific changes in the position of the striker 224 within the receiving slot 220 when the latch 200 is in the primary, fully latched position. For example, the mounting hole 240a may be positioned to result in the latch 200 reaching the primary, fully latched position when the striker 224 is at a first position within the receiving slot 220, and the mounting hole 240b may be positioned to result in the latch 200 reaching the primary, fully latched position when the striker 224 is in a second position that is one millimeter (or two millimeters, or three millimeters, or at least one millimeter but not more than three millimeters, or at least one millimeter but not more than two millimeters, or at least two millimeters but not more than three millimeters, or no more than one millimeter, or no more than two millimeters, or no more than three millimeters) closer to the open end of the receiving slot 220 than in the first position. Similarly, the mounting hole 240c may be positioned to result in the latch 200 reaching the primary, fully latched position when the striker 224 is in a third position that is one millimeter (or two millimeters, or three millimeters, or at least one millimeter but not more than three millimeters, or at least one millimeter but not more than two millimeters, or at least two millimeters but not more than three millimeters, or no more than one millimeter, or no more than two millimeters, or no more than three millimeters) closer to the open end of the receiving slot 220 than in the second position. Although various distances and ranges of distances are provided as examples herein, each mounting hole 240 may be arranged to correspond to larger or smaller changes in the amount of distance between the first, second, and third positions.

Moreover, in some embodiments, the difference in the distances that the striker 224 must travel to move the latch cam 208 into a primary, fully engaged position when the primary pawl 232 is in the second mounting hole 240b as compared to when the primary pawl 232 is in the first mounting hole 240a may be larger or smaller than (rather than equal to) the difference in the distances that the striker 224 must travel to move the latch cam 208 into a primary, fully engaged position when the primary pawl 232 is in the third mounting hole 240c as compared to when the primary pawl 232 is in the second mounting hole 240b. In other words, while moving the primary pawl 232 from the first mounting hole 240a to the second mounting hole 240b may result in the striker 224 traveling 1 mm (or some other first distance) less to push the latch cam 208 into a primary, fully engaged position, moving the primary pawl 232 from the second mounting hole 240b to the third mounting hole 240c may result in the striker 224 traveling 2 mm (or some other second distance different than the first distance) to push the latch cam 208 into a primary, fully engaged position.

Turning now to FIGS. 3A and 3B, a latch 300 is the same as the latch 200, except that the primary pawl 232 has been removably attached (using the pivot 236) to the mounting hole 240b, rather than to the mounting hole 240a (as was the case in FIGS. 2A-2E, with the latch 200). Additionally, the spring holder 228 of the latch 200, which according to some embodiments is removably attached to the mounting plate 204, has been replaced by a longer spring holder 328, such that the same spring 230 as was used to bias the primary pawl 232 of the latch 200 away from the spring holder 228 may be used to bias the primary pawl 232 away from the spring holder 328. The latch 300 operates in the same manner as the latch 200, except that the latch cam 208 does not have to rotate as far to engage the primary pawl 232 and reach the primary, fully engaged position (shown in FIG. 3B). In other words, the striker 224 does not have to move as far up the receiving slot 220 in order to move the latch 300 into the primary, fully latched position.

Similarly with respect to FIGS. 4A and 4B, a latch 400 is the same as the latches 200 and 300, except that the primary pawl 232 has been removably attached (using the pivot 236) to the mounting hole 240c, rather than to the mounting holes 240a or 240b. Additionally, the spring holders 228 and 238 of the latches 200 and 300, respectively, have been replaced by a longer spring holder 428, such that the same spring 230 can be used to bias the primary pawl 232 away from the spring holder 428 as was used to bias the primary pawl 232 of the latches 200 and 300 away from the spring holders 228 and 328, respectively. The latch 400 operates in the same manner as the latches 200 and 300, except that the latch cam 208 reaches the primary, fully latched position (shown in FIG. 4B) after rotating through a lesser angular distance than is required for the latch cam 208 to reach the primary, fully latched position in the latches 300 and 200.

As may be appreciated based on the foregoing disclosure, embodiments of the latch with adjustable primary/final position as disclosed herein may be used to significantly reduce the amount of time needed to configure a latch after installation of the same. Instead of having to detach and re-attach the entire latch in an iterative fashion until the latch reaches the primary, fully engaged position when the corresponding door, hood, or other latching vehicle component is properly closed (e.g., such that the door, hood, or other latching component properly aligns with the body panels 108 of the vehicle 100), the position of the primary pawl 232 of the latches of the present disclosure may simply be moved from one mounting hole 240 to another, and a corresponding spring holder may be installed. For example, if a latch associated with a vehicle door 160 reaches the primary, fully latched position before the outer surface of the vehicle door 160 is flush with the surrounding body panels 108 of the vehicle 100, then the position of the primary pawl 232 can be adjusted so that the latch cam 208 must rotate further (and therefore so that the striker 224 must travel farther up the receiving slot 220) to reach the primary, fully engaged position. Alternatively, if a latch associated with a vehicle door 160 reaches the primary, fully latched position after the outer surface of the vehicle door 160 has passed the point of being flush with the surrounding body panels 108 of the vehicle 100, then the position of the primary pawl 232 can be adjusted so that the latch cam 208 rotates less (and therefore so that the striker 224 travels a shorter distance up the receiving slot 220) before reaching the primary, fully engaged position.

The present disclosure also encompasses embodiments in which a latch comprises only two mounting holes 240, or more than three mounting holes 240. The number of mounting holes provided on the mounting plate of a given latch according to embodiments of the present disclosure may be selected based on the tolerances associated with the latch itself as well as the tolerances of the vehicle 100 on which the latch will be installed (including the tolerances of the door 160, hood 116, or other latching component with which the latch will be used, and the tolerances of the structure to which latch and a corresponding striker will be affixed). Where the tolerances are larger, the number of mounting holes may be increased, to account for the larger possible variation in the relative positions of the latch, the striker, the latching component, and the vehicle 100. Similarly, one or more of the same tolerances may be taken into account in determining the desired striker travel distances corresponding to each mounting hole. For example, when the tolerances of the applicable components and structures are tight, the mounting holes on a latch according to embodiments of the present disclosure may be spaced to result in the striker travel distance changing by, e.g., 1 mm when the primary pawl is moved from one mounting hole to an adjacent mounting hole. When the tolerances of the applicable components and structures are not as tight, the mounting holes on a latch according to embodiments of the present disclosure may be spaced to result in the striker travel distance changing by, e.g., 3 mm when the primary pawl is moved from one mounting hole to an adjacent mounting hole.

Also, according to embodiments of the present disclosure, a latch such as the latches 200, 300, and 400 may comprise one or more electrical switches for detecting the position of the latch cam 208 relative to the other components of the latch. For example, a switch may be provided on the latch 200 and configured to close when the latch cam 208 is in a primary, fully engaged position. In some embodiments, a potentiometer may be operably connected to the latch cam 208, and used for determining a rotational position of the latch cam 208. Additionally or alternatively, a switch may be provided on the latch 200 and configured to close when one or both of the primary pawl 232 and the secondary pawl 248 are in the latched positions. Another switch may be provided on or near the stopper 216 and configured to close when the latch cam 208 is in contact with the stopper 216. Other switches may be provided on the latch 200 and configured to close when the primary pawl 232 is in the first mounting hole 240a, the second mounting hole 240b, or the third mounting hole 240c. (Information about whether the primary pawl 232 is in the first, second, or third mounting hole 240 may be needed, for example, because the position of the latch cam 208 when it is in the primary, fully engaged position varies based on in which mounting hole 240 the primary pawl 232 is installed.) One or more such switches may be used to provide an indication (e.g., on an instrument panel of the vehicle 100) to a user of the vehicle 100 when a latch associated with a door, hood, or other latching component is not in the primary, fully latched position. In some embodiments, one or more such switches may be used to report to a user whether a given latch is in the primary, fully engaged position; the secondary, partially engaged position; or in an open position. Any such indications may enhance the safety of the vehicle 100 by helping to ensure that the vehicle 100 is not inadvertently operated with a door, hood, or other latching component in an unlatched position.

In some embodiments, one or more of the switches described above may be replaced by other sensors that are configured to determine a position of one or more components of a latch such as the latches 200, 300, and 400. Such other sensors may comprise, for example, a Hall effect sensor, a pressure sensor, a variable reluctance sensor, a current sensor, a magnetometer, a voltage detector, a capacitive displacement sensor, and any other suitable sensor.

A latch according to some embodiments of the present disclosure may comprise a primary pawl 232, but may omit the secondary pawl 248 (together with the spring holder 244, the spring 246, and the pivot 252). In such embodiments, the latch cam 208 has only a primary, fully engaged position, and does not have a secondary, partially engaged position.

A number of variations and modifications of the disclosure can be used. It would be possible to provide for some features of the disclosure without providing others.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

A latch according to one embodiment of the present disclosure comprises: a mounting plate comprising a receiving slot and a plurality of primary pawl mounting holes; a latch cam rotatably attached to the mounting plate adjacent the receiving slot, the latch cam rotatable from an open position to a locked position, the latch cam comprising a latch cam slot; a pivot removably attached to one of the plurality of primary pawl mounting holes; and a primary pawl rotatably secured to the pivot, the primary pawl configured to engage the latch cam when the latch cam is rotated from the open position to the locked position, and to selectively prevent rotational movement of the latch cam from the locked position to the open position.

Aspects of the above latch include: a spring holder removably attached to the mounting plate; a spring supported between the primary pawl and the spring holder, the spring configured to bias the primary pawl toward the latch cam; wherein the spring is a compression spring; wherein the spring is an extension spring; wherein the spring is a torsion spring; wherein the plurality of mounting holes comprises at least three mounting holes; wherein a first angular distance travelled by the latch cam between the open position and the locked position when the pivot is removably attached to a first one of the plurality of mounting holes is different than a second angular distance travelled by the latch cam between the open position and the locked position when the pivot is removably attached to a second one of the plurality of mounting holes; wherein the receiving slot and the latch cam slot are adapted to receive a striker, and further wherein when the latch cam is in the closed position, the latch cam prevents the striker from exiting the receiving slot; and wherein the striker is in a first position in the receiving slot when the pivot is in a first one of the plurality of primary pawl mounting holes and the latch cam is in the closed position, and the striker is in a second position in the receiving slot different than the first position when the pivot is in a second one of the plurality of primary pawl mounting holes and the latch cam is in the closed position.

A latch according to another embodiment of the present disclosure comprises: a mounting plate comprising a receiving slot and at least two mounting holes; a latch cam rotatably secured to the mounting plate adjacent the receiving slot; a pivot removably secured to one of the at least two mounting holes; a primary pawl rotatably secured to the pivot; a secondary pawl rotatably secured to the mounting plate; wherein the latch cam is movable between an open position, a partially engaged position in which the secondary pawl selectively prevents rotation of the latch cam in a rotational direction, and a fully engaged position in which the primary pawl selectively prevents rotation of the latch cam in the rotational direction.

Aspects of the above latch include: wherein the fully engaged position corresponds to a first rotational position of the latch cam when the pivot is removably secured to a first one of the at least two mounting holes, and the fully engaged position corresponds to a second rotational position of the latch cam, different than the first rotational position, when the pivot is removably secured to a second one of the at least two mounting holes; wherein the latch is adapted to secure a striker within the receiving slot when the latch cam is in the fully engaged position, and further wherein the first rotational position corresponds to a first location of the striker within the receiving slot, and the second rotational position corresponds to a second location of the striker within the receiving slot, the first location offset from the second location; wherein the first location is offset from the second location by 2 mm; and at least one sensor configured to detect when the latch cam is in the fully engaged position; a first biasing member positioned to bias the primary pawl toward the latch cam, and a second biasing member positioned to bias the secondary pawl toward the latch cam.

A vehicle according to yet another embodiment of the present disclosure comprises: a striker; and a latch, the latch comprising: a mounting plate comprising a receiving slot and a plurality of mounting locations; a latch cam rotatably secured to the mounting plate, the latch cam rotatable from an open position to a fully engaged position; and a primary pawl removably and rotatably attached to the mounting plate at one of the plurality of mounting locations, the primary pawl configured to selectively prevent movement of the latch cam from the fully engaged position to the open position; wherein the latch is positioned to selectively receive the striker in the receiving slot when the latch cam is in the open position, and further wherein the striker is secured in the receiving slot when the latch cam is in the fully engaged position.

Aspects of the above vehicle include: wherein the fully engaged position corresponds to a first position of the striker in the receiving slot when the primary pawl is removably attached to a first one of the plurality of mounting locations, and the fully engaged position corresponds to a second position of the striker in the receiving slot when the primary pawl is removably attached to a second one of the plurality of mounting locations, the second position offset from the first position; wherein the first position is offset from the second position by at least 1 mm and not more than 3 mm; and a secondary pawl rotatably attached to the mounting plate, wherein the latch cam is further rotatable to a partially engaged position in between the open position and the fully engaged position, the secondary pawl engaging the latch cam when the latch cam is in the partially engaged position.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

What is claimed is:

1. A latch comprising:
a mounting plate comprising a receiving slot and a plurality of primary pawl mounting holes;
a latch cam rotatably attached to the mounting plate adjacent the receiving slot, the latch cam rotatable from an open position to a locked position, the latch cam comprising a latch cam slot;
a pivot removably attached to one of the plurality of primary pawl mounting holes; and
a primary pawl rotatably secured to the pivot, the primary pawl configured to engage the latch cam when the latch cam is rotated from the open position to the locked position, and to selectively prevent rotational movement of the latch cam from the locked position to the open position.

2. The latch of claim 1, further comprising a spring holder removably attached to the mounting plate.

3. The latch of claim 2, further comprising a spring supported between the primary pawl and the spring holder, the spring configured to bias the primary pawl toward the latch cam.

4. The latch of claim 3, wherein the spring is a compression spring.

5. The latch of claim 3, wherein the spring is an extension spring.

6. The latch of claim 3, wherein the spring is a torsion spring.

7. The latch of claim 1, wherein the plurality of mounting holes comprises at least three mounting holes.

8. The latch of claim 1, wherein a first angular distance travelled by the latch cam between the open position and the locked position when the pivot is removably attached to a first one of the plurality of mounting holes is different than a second angular distance travelled by the latch cam between the open position and the locked position when the pivot is removably attached to a second one of the plurality of mounting holes.

9. The latch of claim 1, wherein the receiving slot and the latch cam slot are adapted to receive a striker and wherein, when the latch cam is in the closed position, the latch cam prevents the striker from exiting the receiving slot.

10. The latch cam of claim 9, wherein the striker is in a first position in the receiving slot when the pivot is in a first one of the plurality of primary pawl mounting holes and the latch cam is in the closed position, and the striker is in a second position in the receiving slot different than the first position when the pivot is in a second one of the plurality of primary pawl mounting holes and the latch cam is in the closed position.

11. A latch comprising:
a mounting plate comprising a receiving slot and at least two mounting holes;
a latch cam rotatably secured to the mounting plate adjacent the receiving slot;
a pivot removably secured to one of the at least two mounting holes;
a primary pawl rotatably secured to the pivot; and
a secondary pawl rotatably secured to the mounting plate;
wherein the latch cam is movable between an open position, a partially engaged position in which the secondary pawl selectively prevents rotation of the latch cam in a rotational direction, and a fully engaged position in which the primary pawl selectively prevents rotation of the latch cam in the rotational direction.

12. The latch of claim 11, wherein the fully engaged position corresponds to a first rotational position of the latch cam when the pivot is removably secured to a first one of the at least two mounting holes, and the fully engaged position corresponds to a second rotational position of the latch cam, different than the first rotational position, when the pivot is removably secured to a second one of the at least two mounting holes.

13. The latch of claim 12, wherein the latch is adapted to secure a striker within the receiving slot when the latch cam is in the fully engaged position and wherein the first rotational position corresponds to a first location of the striker within the receiving slot, and the second rotational position corresponds to a second location of the striker within the receiving slot, the first location offset from the second location.

14. The latch of claim 13, wherein the first location is offset from the second location by about 2 mm.

15. The latch of claim 11, further comprising at least one sensor configured to detect when the latch cam is in the fully engaged position.

16. The latch of claim 11, further comprising a first biasing member positioned to bias the primary pawl toward the latch cam, and a second biasing member positioned to bias the secondary pawl toward the latch cam.

17. A vehicle comprising:
a striker; and
a latch, the latch comprising:
a mounting plate comprising a receiving slot and a plurality of mounting locations;
a latch cam rotatably secured to the mounting plate, the latch cam rotatable from an open position to a fully engaged position; and
a primary pawl removably and rotatably attached to the mounting plate at one of the plurality of mounting locations, the primary pawl configured to selectively prevent movement of the latch cam from the fully engaged position to the open position;
wherein the latch is positioned to selectively receive the striker in the receiving slot when the latch cam is in the open position and wherein the striker is secured in the receiving slot when the latch cam is in the fully engaged position.

18. The vehicle of claim 17, wherein the fully engaged position corresponds to a first position of the striker in the receiving slot when the primary pawl is removably attached to a first one of the plurality of mounting locations, and the fully engaged position corresponds to a second position of the striker in the receiving slot when the primary pawl is removably attached to a second one of the plurality of mounting locations, the second position offset from the first position.

19. The vehicle of claim 18, wherein the first position is offset from the second position by at least about 1 mm and not more than about 3 mm.

20. The vehicle of claim 17, further comprising a secondary pawl rotatably attached to the mounting plate, wherein the latch cam is further rotatable to a partially engaged position in between the open position and the fully engaged position, the secondary pawl engaging the latch cam when the latch cam is in the partially engaged position.
